(19) United States
(12) Patent Application Publication
(10) Pub. No.: US 2007/0131177 A1
(43) Pub. Date: Jun. 14, 2007

(54) Motorized pet leash assembly

(76) Inventor: Jerzy Perkitny, Lakewood, OH (US)

Correspondence Address: Jay F. Moldovanyi, Esq.;Fay, Sharpe, Fagan, Minnich & McKee, LLP, Seventh Floor, 1100 Superior Avenue, Cleveland, OH, 44114-2579, US

(21) Appl. No.: 11/375,900

(22) Filed: Mar. 15, 2006

Related U.S. Application Data
(60) Provisional application No. 60/662,698, filed on Mar. 17, 2005.

(51) Int. Cl. A01K 27/00

(52) U.S. Cl. 119/796

(57) ABSTRACT

The present invention relates to a motorized dog leash. The motorized dog leash includes a housing, a battery mounted to the housing, and a motor mounted to the housing and electrically connected to the battery. A gear train is connected to an output shaft of the motor. A spool is rotatably mounted to the housing and engaged with the gear train. A leash is selectively wound on the spool, the leash including a distal end which protrudes from the housing. A trigger selectively actuates the motor to rotate the spool.

### CROSS REFERENCE TO RELATED APPLICATIONS

This application claims priority from U.S. Provisional Patent Application Ser. No. 60/662,698 filed Mar. 17, 2005 and is incorporated herein by reference.

### BACKGROUND OF THE INVENTION

The present invention relates, generally, to a restraining device for a pet. More particularly, the present invention relates to a motorized, retractable pet leash that allows the user to manually control a pet without injury.

Pet owners commonly restrain their pets using leashes. The typical leash includes an elongated strap or braided nylon cord having, at one end, a loop or handle for grasping by the pet owner and, at the other end, a clasp that attaches the leash to the pet's collar. One common type of leash is the retractable leash. This design employs a housing having a mechanism (e.g. a spring-driven mechanism) for automatically retracting the leash into the housing for shortening the leash cord and for storing the leash cord when the leash is not in use. Such leashes can provide effective means of restraining a pet during simple “walks” or during training.

Retractable pet leashes generally enable the user having a pet tethered to a leash cord to fluidly adapt to changing spatial relationships between the user and the pet. Conventionally, retractable leash assemblies generally operate in two modes. A first mode provides a spring loaded tension on the retractable leash cord. The spring-loaded tension causes the leash cord to retract as slack develops, extends as the owner allows the pet to roam at a further distance, and stops the leash from dragging on the ground. A second, locking, mode removes the spring-loaded tension and stops the leash from either retracting or extending.

One disadvantage of traditional retractable pet leash assemblies is that the switching mechanism for selecting between a spring-loaded tension mode and a locked mode of operation is somewhat clumsy to operate. Some prior systems require a constant force to be applied to a braking mechanism to maintain the leash cord in a locked mode. In other conventional retractable pet leash assemblies, the locked mode is maintained by applying a locking pin to the brake mechanism. Quite often such leash assemblies require the use of both hands, or require difficult single-handed motions to transit between the locked and spring-loaded tension modes of operation.

Moreover, conventional leash assemblies do not enable a pet owner to retract the leash into the housing when the pet exerts more tension on the leash than the retraction force supplied by the spring bias on the spool on which the leash is wrapped. The pet owner has to manually grasp the leash to pull the pet towards him, causing slack in the line, thereby allowing the spring driven mechanism to retract the leash. But, grasping the leash may injure the owner's hand, particularly when the pet is pulling strongly on the leash.

In light of the foregoing, it becomes evident that there is a need for a retractable pet leash assembly that would provide a solution to one or more of the deficiencies from which the prior art and/or conventional leash assemblies have suffered. Accordingly, the present invention provides a new and improved ergonomic motorized retractable pet leash assembly.

### BRIEF DESCRIPTION OF THE INVENTION

In an exemplary embodiment of the present disclosure, a motorized pet leash assembly is provided.

More particularly, in accordance with this aspect of the present invention, a motorized dog leash comprises a housing, a battery mounted to the housing, and a motor mounted to the housing and electrically connected to the battery. A gear train is connected to an output shaft of the motor. A spool is rotatably mounted to the housing and engaged with the gear train. A leash is selectively wound on the spool, the leash including a distal end which protrudes from the housing. A trigger selectively actuates the motor to rotate the spool.

In accordance with another aspect of the present invention, a motorized dog leash comprises a housing, a battery mounted to the housing, and a spool mounted to the housing, the spool having an axis of rotation. A spooling mechanism enables a powered retraction of the leash. The spooling mechanism includes a motor and a gear train. The motor is mounted to the housing and electrically connected to the battery, the motor having an axially rotated output drive shaft. The gear train is connected to the drive shaft for rotation therewith. The spooling mechanism is pivotable about the output drive shaft of the motor around a pivot axis for allowing the gear train to be selectively engaged with the spool. A leash is at least partially wound about the spool. A trigger assembly selectively actuates the spooling mechanism for extension or retraction of the leash.

In accordance with yet another aspect of the present invention, a motorized dog leash comprises a housing, a battery compartment located in the housing for accommodating a battery, and a spool rotatably mounted in the housing. The spool includes at least one flange and a lip including teeth. A spooling mechanism enables a powered retraction of the leash. The spooling mechanism includes a motor, a gear train and a support member. The motor is electrically connected to the battery and has an axially rotated output drive shaft. The gear train includes at least one drive gear and at least one compound gear. The gear train is connected to the drive shaft for rotation therewith. The support member is pivotable about the output drive shaft of the motor around a pivot axis for allowing the gear train to be selectively engaged with teeth of the lip of the spool. A leash is at least partially wound about the spool. A trigger selectively actuates the spooling mechanism for extension or retraction of the leash.

Still other non-limiting aspects of the present invention will become apparent from a reading and understanding of the description of the preferred embodiments hereinbelow.

### BRIEF DESCRIPTION OF THE DRAWINGS

The present invention may take physical form in certain parts and arrangements of parts, preferred embodiments of which will be described in detail in this specification and illustrated in the accompanying drawings which form a part hereof.

FIG. 1 is a left side partial cross-sectional view of a motorized pet leash assembly according to a first embodiment of the present invention.

FIG. 2A is a left side elevational view of the motorized pet leash assembly of FIG. 1, with a housing half removed.

FIG. 2B is a left side elevational view of the motorized pet leash assembly of FIG. 1, with a housing half removed showing a power spring.

FIG. 3 is a right side elevational view of the motorized pet leash assembly of FIG. 1, with a housing half removed.

FIG. 4 is an enlarged cross-sectional view of a trigger assembly of the motorized pet leash assembly of FIG. 1.

FIG. 5 is a schematic side perspective view of a spool mechanism of the motorized pet leash assembly of FIG. 1.

FIG. 6 is a right side elevational view of a motorized pet leash assembly according to a second embodiment of the present invention, with a housing half removed.

FIG. 7 is a right side elevational view, partially broken away, of a motorized pet leash assembly according to a third embodiment of the present invention.

FIG. 8 is an enlarged top perspective view of a motor and gear housing of the motorized pet leash assembly of FIG. 7.

FIG. 9 is a front perspective view of a motorized pet leash assembly according to a fourth embodiment of the present invention.

FIG. 10 is a rear perspective view of the motorized pet leash assembly of FIG. 9.

FIG. 11A is a front exploded perspective view of the motorized pet leash assembly of FIG. 9.

FIG. 11B is a rear exploded perspective view of a spooling mechanism of the motorized pet leash assembly of FIG. 9.

FIG. 12 is an enlarged right side elevational view, partially broken away, of the motorized pet leash assembly of FIG. 9 showing a spool of the motorized pet leash assembly in a first freely rotating, condition.

FIG. 13 is a right side elevational view, partially broken away, of the motorized pet leash assembly of FIG. 12 showing the spool in a second condition engaging a gear train but with a motor not engaged.

FIG. 14 is a right side elevational view, partially broken away, of the motorized pet leash assembly of FIG. 12 showing the spool in a third condition, with the motor driving the spool.

FIG. 15 is a left elevational view of a motorized pet leash assembly according to a fifth embodiment of the present invention.

### DETAILED DESCRIPTION OF THE INVENTION

The description and drawings herein are merely illustrative of several embodiments of the invention. Various modifications and changes can be made to the components and arrangement(s) of components without departing from the spirit of the invention. Like numerals refer to like parts throughout the several views.

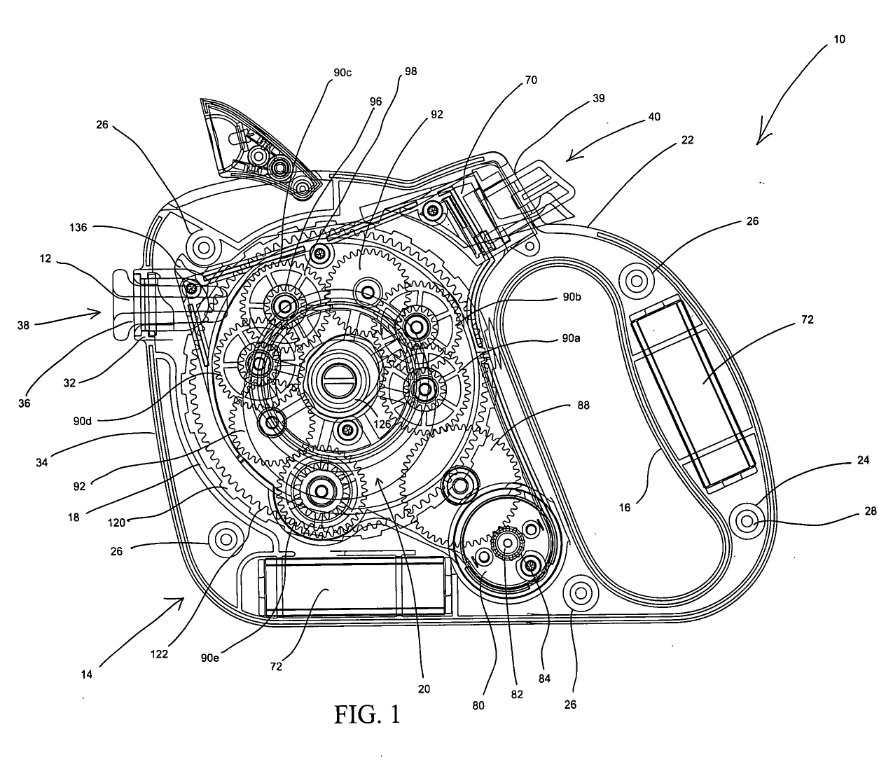

With reference to FIGS. 1-3, a motorized pet leash assembly 10 according to a first embodiment is illustrated. The leash assembly generally includes a length of leash 12, such as a cord, rope, chain, and/or a webbing strip, and a housing 14. The housing 14 includes an ergonomically handle or hand grip portion 16 which can be integrally fabricated with the housing and a spool 18 which houses a portion of a spooling mechanism 20 (FIG. 1). The spooling mechanism includes a gear train and a motor and enables a powered retraction of the leash.

The housing 14 can be a plastic molded component and includes first and second halves 22 and 24 that may be secured together by suitable fasteners. In this embodiment, a plurality of corresponding bosses 26 extend outwardly from the two halves, each boss including an aperture 28 for receiving a fastener (not shown) which threadingly engages the aperture from the exterior of one of the first and second halves 22, 24. A leash opening 32 is provided in a forward facing portion 34 of the housing 14 to enable unhindered movement of the leash between the interior and exterior of the housing. An anti-wear ring 36, which can be made from a lubricious material, such as nylon, can be mounted in the leash opening 32 for buffering the leash through the opening 32 to reduce the frictional wear on the leash due to the leash rubbing against the portion of the housing 14 defining the opening 32. The anti-wear ring 36 can also inhibit the leash 12 from forcing the housing halves 22 and 24 apart during extension and retraction of the leash.

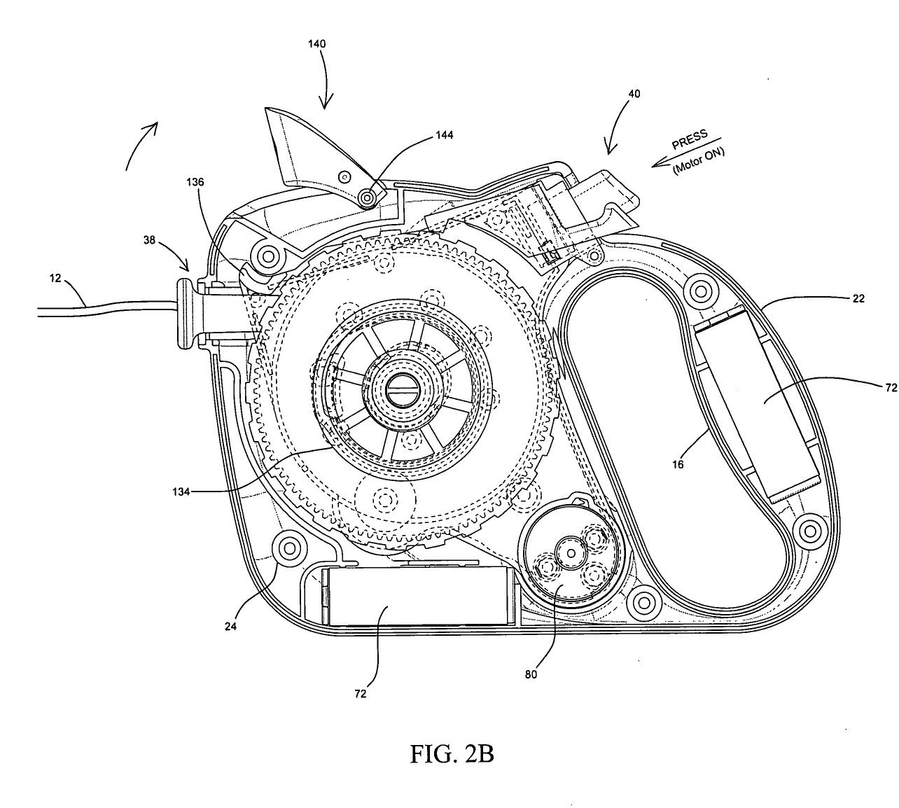

As best shown in FIG. 3, the leash 12 can include a stop member 38 which may be permanently fixed to a portion of the leash. The stop member includes a flange portion and a cylindrical portion having an outer diameter smaller than an inner diameter of the leash opening 32 and the anti-wear ring 36. The flange portion of the stop member has a greater diameter than the opening 32 in the housing 14 such that the flange portion is stopped by the housing 14.

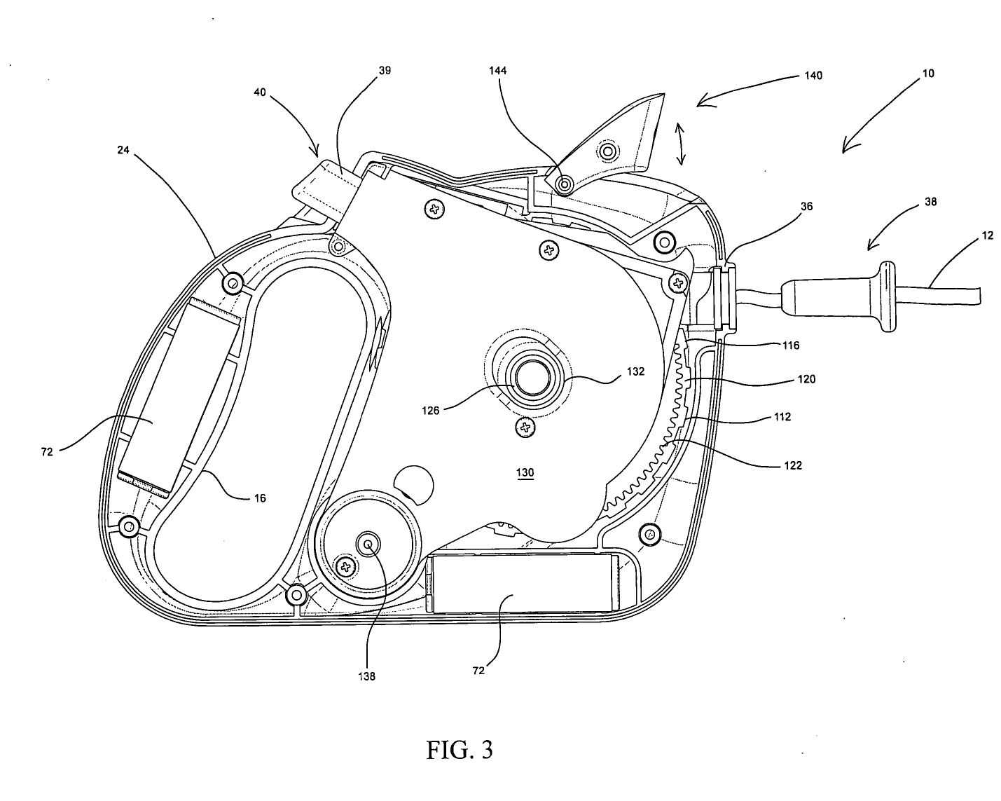

With continued reference to FIGS. 1 and 3, the housing 14 further includes an opening 39 provided for passage of a trigger assembly 40 that activates the spooling mechanism 18 for extension or retraction of the leash 12. As shown in FIG. 4, the trigger assembly includes a cap button 42 operatively mounted to a stem 44. In particular, the cap button includes an inwardly extending flange 46 having a top surface 48 which abuts against a bottom surface 50 of a collar 52 extending outwardly from a top portion of the stem 44. Extending from an inner top surface of the cap button 42 into an inner channel 54 of the stem is a projection 56 adapted to slidingly receive a spring 60. The spring is positioned in a compressed state between the inner top surface of the cap button and a channel shelf 62. Thus, the spring outwardly biases the cap button. A switch 66, which actuates the spool mechanism 18, is mounted to a bottom surface 68 of the channel 54. To engage the switch, the cap button 42 is pushed downwardly onto the stem 44 thereby moving the projection 54 into contact with the switch. The switch 66 is electrically connected to batteries (FIG. 3) 72 mounted in the housing 14, which provide power to a motor 80.

The location of the trigger assembly 40 enables a user to actuate the trigger assembly with a thumb, while using the remaining fingers of the grasping hand to hold onto the grip portion 16. Actuating the trigger assembly 40 inhibits the leash 12 from extending from the housing 14 and actuates the spool mechanism 20, which retracts the leash into the housing 14.

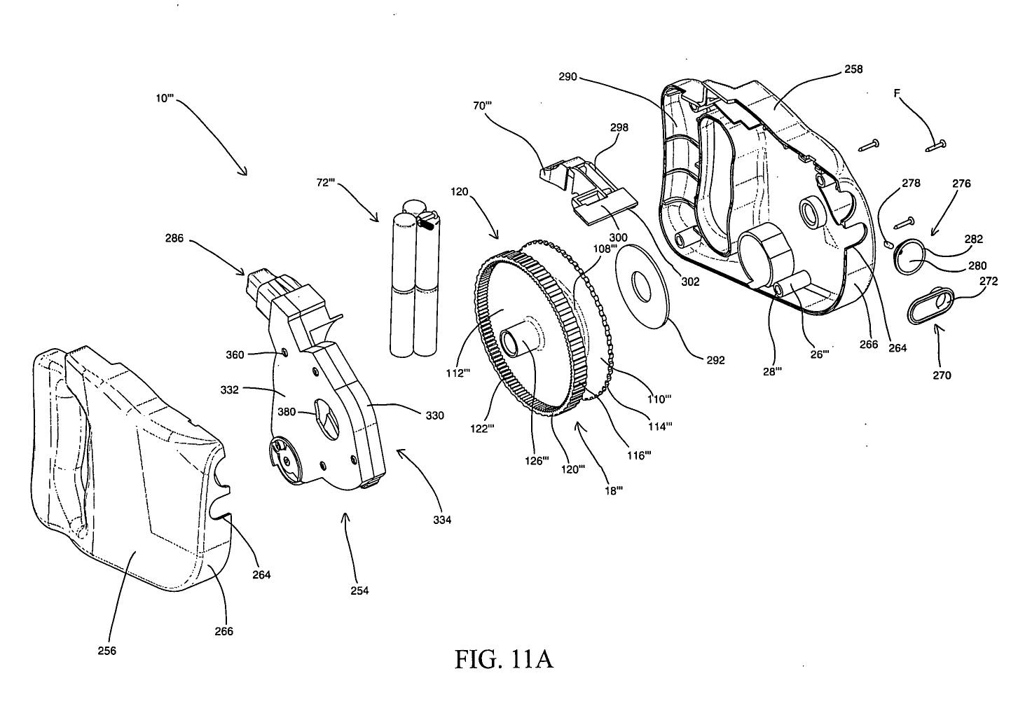

With continued reference to FIG. 1, a leash stop lock button 70 can be mounted to the housing 14, adjacent the trigger assembly 40. The spatial relationship of these two elements is more clearly illustrated in the embodiment disclosed by FIG. 10. The feature of the leash stop lock button 70 will be discussed in greater detail below with reference to a fourth embodiment of the motorized pet leash assembly 10. The leash stop lock button can be located proximate to the handle grip portion 16 and operates in a first locked position to lock the spool 18, and in a second unlocked position that enables the spool to freely rotate. The trigger assembly 40 and the leash stop lock button 70 can be positioned proximate to each other so that the same hand can grasp the grip portion, actuate the trigger assembly with one finger, and operate the leash stop lock button. The location of the leash stop lock button 70 enables easy operation with the thumb of the grasping hand, thereby leaving the user's other hand completely free.

With reference again to FIG. 1, the motor 80 of the spooling mechanism 18 includes a drive shaft 82 and a spur gear 84 securely mounted to an end of the drive shaft. The spooling mechanism further includes a gear train comprising a first gear 88 and a plurality of second or compound gears 90 and third or connecting gears 92. The second and third gears have a general planetary arrangement. Each compound gear is smaller in diameter than the first gear and includes a small gear portion 96 concentrically secured to a large gear portion 98. In the present embodiment, five compound gears (90a through 90e) and two connecting gears 92 are provided. However, it should be appreciated that more or less than five compound gears and two connecting gears can be implemented to achieve the desired gear reduction. In one embodiment, a 500 to 1 gear reduction is obtained.

In operation, and as stated above, the trigger assembly actuates the motor 80 which, in turn, rotates the spur gear 84. The spur gear actuates the larger first gear 88 thereby providing a high gear ratio between the spur gear and the first gear. The first gear 88, in turn, actuates the plurality of compound gears 90 and connecting gears 92. In particular, the first gear 88 engages large gear portion 98a thereby actuating compound gear 90a. Small gear portion 96a of compound gear 90a engages large gear portion 98b thereby actuating compound gear 90b. Small gear portion 96b of compound gear 90b actuates one of the connecting gears 92 which, in turn, engages large gear portion 98c thereby actuating compound gear 90c. The actuation of compound gear 90d, the second connecting gear 92 and compound gear 90e is similar to that described above. As shown in FIG. 1, compound gear 90e actuates the spool 18. As the spool rotates in a counterclockwise direction, the leash 12, which has one end secured to a hub 108 of the spool, retracts and is wound or coiled about the hub. As mentioned, the gear arrangement of the present embodiment can provide approximately a 500 to 1 gear reduction. It can be appreciated by one skilled in the art that such a gear reduction will allow the motor 80, which can be a conventional fractional horsepower electric motor powered by conventional batteries 72, to retract the leash 12, even when tethered to a large pet.

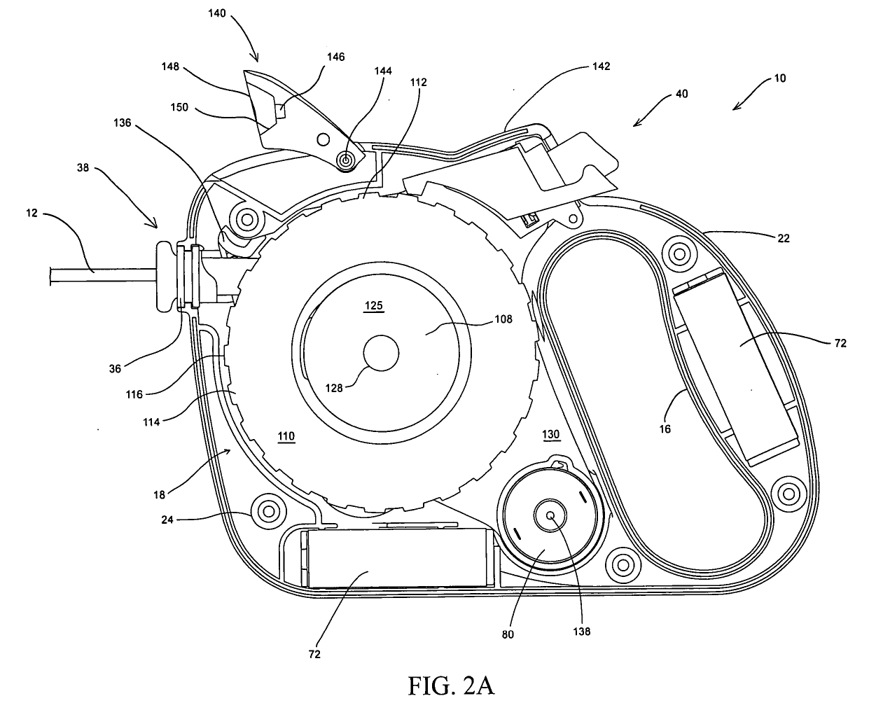

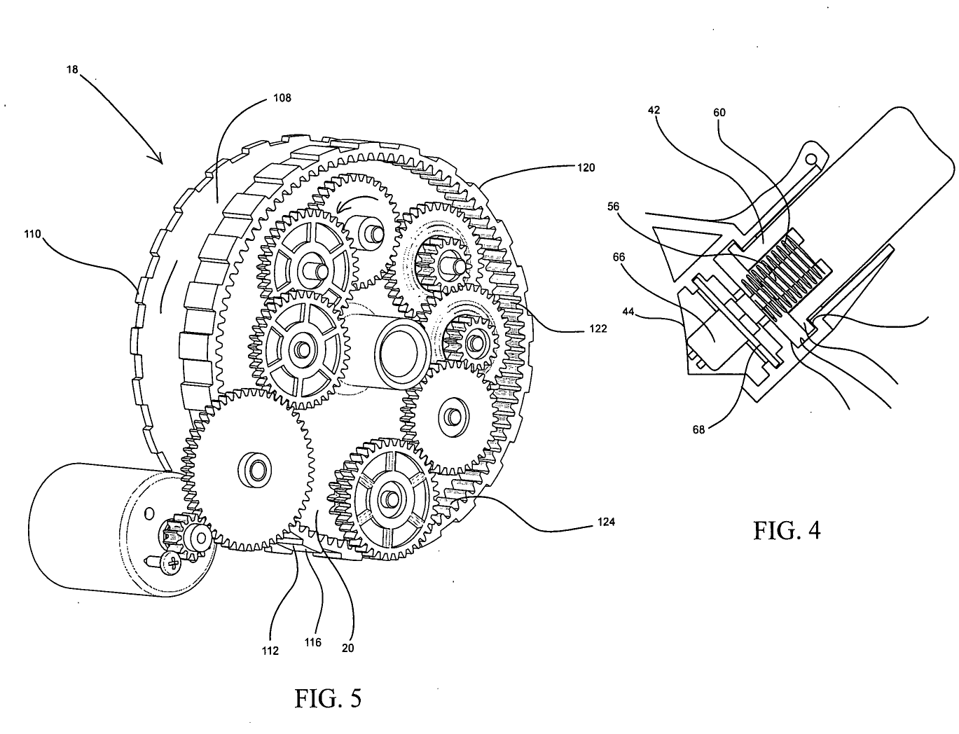

With reference to FIG. 5, extending from the hub 108 are first and second flanges 110 and 112, a periphery of both flanges including teeth 114 and 116, respectively. Extending outwardly from the second flange 112 is a lip 120 including teeth 122 disposed radially about an inner surface 124. The teeth 122 are engaged by the small gear portion 96e of compound gear 90e. As shown in FIG. 2A, a portion of the hub 108 is slightly offset from the first flange 110 thereby forming a cavity 125. As shown in FIG. 3, a hollow stem 126 extends outwardly from the second flange 116, a longitudinal axis of the stem being coincident with a rotational axis of the spool 18. The spool 18 includes a mounting opening 128 adapted to rotatably receive a shaft portion (not shown) extending from the second half 24 of the housing 14. Thus, the spool can freely rotate in the housing.

With reference again to FIG. 3, the spooling mechanism 20 (not visible) is mounted to a support member 130, which can be a plate. The support member includes an elongated opening 132 which allows the stem 126 of the spool 18 to protrude therethrough. The support member 130 is pivotable about the drive shaft 82 of the motor 80, around a pivot axis 138. As will be described in more detail below with reference to a fourth embodiment of the motorized pet leash assembly 10, the support member, which can be a gear train housing, allows the spooling mechanism 20 to be selectively engaged with the spool 18 as the trigger assembly 40 is being depressed.

It should be appreciated that the spool 18 can be spring biased which enables the spool to freely retract any slack in the leash 12. As shown in FIG. 2B, the hub 108 can include a power spring 134 dimensioned to fit within the cavity 125 (FIG. 2A). A radially outer end of the power spring can attach to a portion of the hub 108 to fasten the power spring in the cavity 125. A radially inner end of the power spring can attach to one of the stem 126 and the shaft portion extending from the second half 24 of the housing 14. In this embodiment, the power spring 134 is secured to the stem 126. The power spring 134 is initially coiled to spring bias the spool 18 to retract the leash 12. Additionally, as the spool 18 rotates to extend the leash 12 out of the housing 14, the power spring 134 coils further, thereby providing additional retracting bias as the extended portion of the leash increases. This is conventional. Alternatively, the powered retraction mechanism disclosed herein can be used to wind the leash 12 back on the spool 18 after the tethered pet has played out the leash.

With continued reference to FIGS. 1-2B, a contact arm 136 can be secured to the support member 130 near the leash opening 32, for rotating the spooling mechanism 20 out of engagement with the spool 18. Particularly, as the leash 12 is being retracted into the housing 14 and coiled about the spool 18, a rear end of the stop member 38 will enter the leash opening 32. As the stop member rear end engages the contact arm 136, it will cause the support member 130 to rotate about the pivot axis 138 thereby moving compound gear 90e out of engagement with the teeth 122 of the spool 18.

As shown in FIGS. 2A-3, a light assembly 140 can be pivotally mounted to a top portion 142 of the housing 14 via a pivot pin 144. The light assembly includes a light bulb 146, a clear lens 148 and a reflector 150. The light assembly 140 can be operated by a contact switch (not shown). The contact switch can be electrically connected to the batteries 72 such that as the light assembly is being pivoted upward, power will be supplied to the light bulb thus illuminating the light assembly 140.

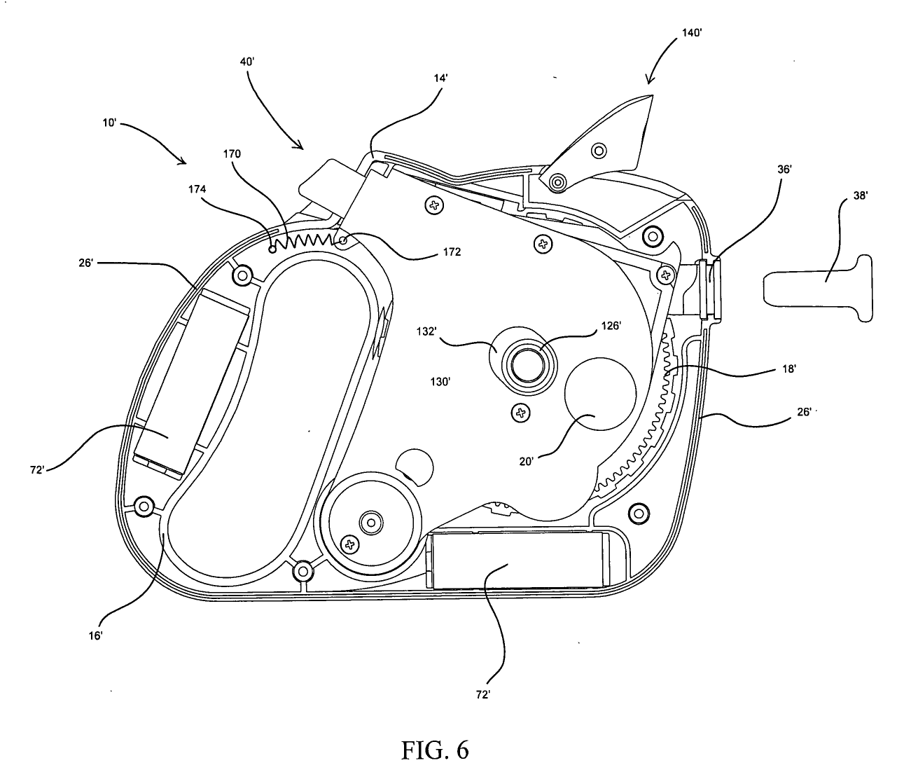

Similar to the aforementioned embodiment, a second embodiment is shown in FIG. 6. Since most of the structure and function is substantially identical, reference numerals with a single primed suffix (′) refer to like components (e.g. the motorized pet leash assembly is referred to by reference numeral 10′), and new numerals identify new components in the additional embodiment.

As shown in FIG. 6, a spring 170 can be secured to a tab 172 of the support member 130′ at one end and a pin 174 extending from the second half 26′ of the housing 14′ near the handle 16′. As described above, to actuate the spooling mechanism 20′, a user depresses the trigger assembly 40′. This action will pivot the support member 130′ about the stem 126′ of the spool 18′ thereby bringing the compound gear (not shown) of the spooling mechanism 20′ into contact with the spool 18′. Once the trigger assembly is released, the spring retracts the spooling mechanism, which causes the spooling mechanism to pivot about the stem of the spool 18′, out of engagement with the spool thereby allowing the spool to freely rotate within the housing 14′.

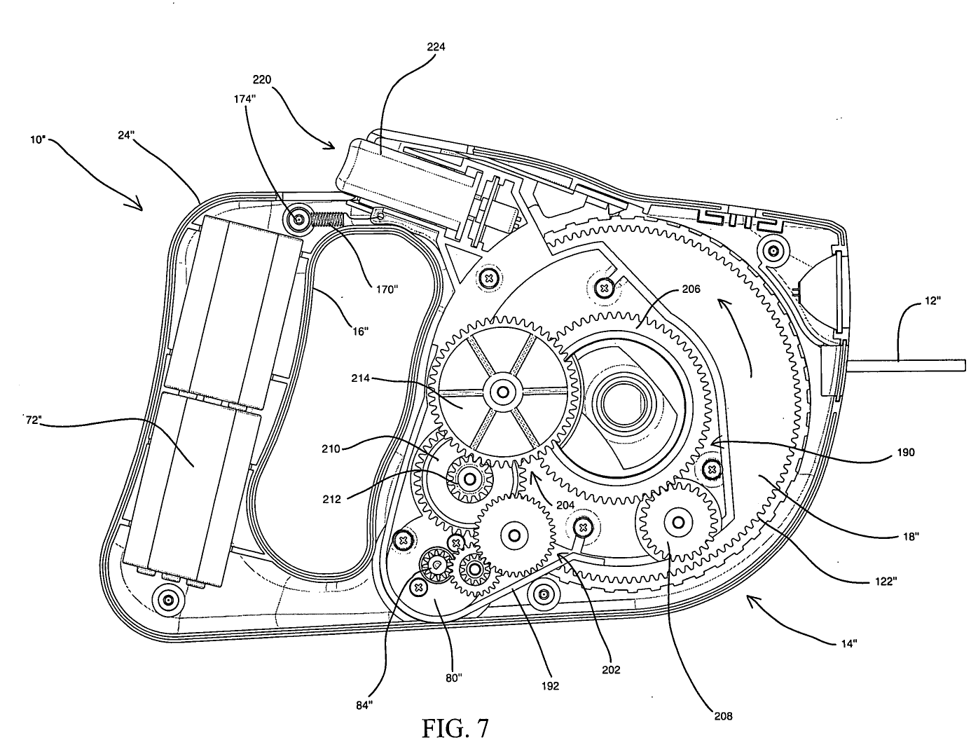

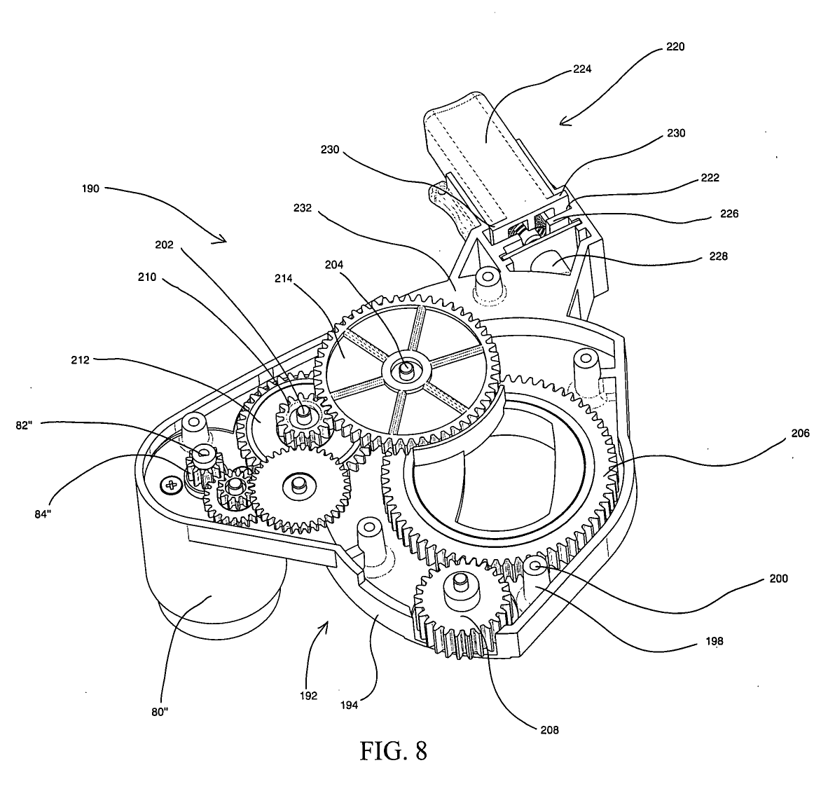

Similar to the aforementioned embodiment, a third embodiment is shown in FIGS. 7 and 8. Since most of the structure and function is substantially identical, reference numerals with a double primed suffix (″) refer to like components (e.g., the motorized pet leash assembly is referred to by reference numeral 10″), and new numerals identify new components in the additional embodiment.

With reference to FIGS. 7 and 8, the motorized pet leash assembly includes a spooling mechanism 190 mounted to a support member 192 having a first half 194 and a mating second half (not shown). A plurality of bosses 198 including mounting apertures 200 extend from the first half. It should be appreciated that the second half includes a plurality of openings which correspond with the apertures 200 of the bosses 198. Conventional fasteners (not shown) can be used to secure the first half 194 to the second half.

The spooling mechanism 190 includes a motor 80″ having a spur gear 84″ rotatably mounted on a drive shaft 82″, first and second compound gears 202 and 204 and first and second drive gears 206 and 208. Similar to the first embodiment, the first compound gear 202 includes a small gear portion 210 concentrically secured to a large gear portion 212. The second compound gear 204 also includes a small gear portion (not shown) concentrically secured to a large gear portion 214.

In operation, the spooling mechanism is actuated by a trigger assembly 220, the trigger assembly actuating the motor 80″ which, in turn, rotates the spur gear 84″. The spur gear engages the large gear portion 212 which actuates the first compound gear 202 thereby providing a high gear ratio between the spur gear and the first compound gear. Small gear portion 210 of the first compound gear 202 engages the large gear portion 214 thereby actuating the second larger compound gear 204. The small gear portion (not shown) of the second compound gear 204 actuates the first drive gear 206 which, in turn, actuates the second smaller drive gear 208. As shown in FIG. 7, the second drive gear engages the teeth 122″ thereby actuating the spool 18″. As the spool rotates in a counterclockwise direction, the leash 12″, which has one end secured to the spool, retracts and is wound about the spool. Thus, the gear arrangement of the present embodiment can also provide approximately a 500 to 1 gear reduction.

With reference to FIG. 8, the trigger assembly 220, which is housed in a recess 222 defined by the first half 194 and the second half (not shown) of the support member 192, includes a cap button 224, a contact plate 226 and a switch assembly 228. A pair of fingers 230 slidably secure the contact plate 226 against a surface 232 of the first half 194 of the support member 192. The switch assembly 228, which actuates the spool mechanism 18″, is mounted to the support member 192. To engage the switch assembly, the cap button 224 is pushed downwardly thereby moving the contact plate 226 into contact with the switch assembly. The switch assembly 228 is electrically connected to batteries 72″ housed in the housing 14″ which also provide power to the motor 80″.

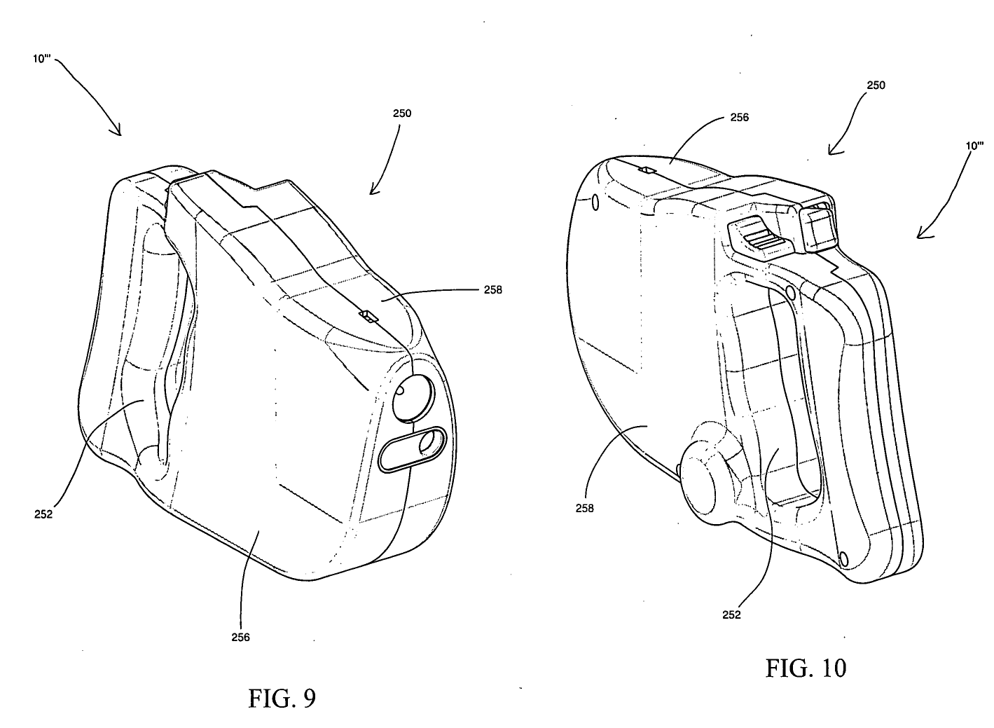

Similar to the aforementioned embodiment, a fourth embodiment is shown in FIGS. 9-14. Since most of the structure and function is substantially identical, reference numerals with a triple primed suffix (′″) refer to like components (e.g., the motorized pet leash assembly is referred to by reference numeral 10′″), and new numerals identify new components in the additional embodiment.

With reference to FIGS. 9-11A, the leash assembly 10′″ includes a housing 250 having an ergonomically shaped handle or hand grip 252 which can be integrally fabricated with the housing and a spool 18′″ which houses a motor and gear train portion of a spooling mechanism 254. The spooling mechanism enables retraction of a leash (not shown). The housing 250 can be a plastic molded component and can be comprised of first and second halves 256 and 258 that may be secured together by suitable fasteners. In this embodiment, a plurality of mating bosses 26′″ extend outwardly from the two halves, each boss including an aperture 28′″ for receiving a fastener F.

A leash opening 264 is provided at a forward facing portion 266 of each half 256 and 258 of the housing to enable unhindered movement of the leash between the interior and exterior of the housing 250. An anti-wear ring 270, which can be made from a lubricious material, such as nylon, includes an opening 272 and is mounted in the leash opening 264 for buffering the leash through the opening 264 to reduce the frictional wear on the leash due to the leash rubbing against housing 250. The anti-wear ring 36 can also inhibit the leash from forcing the housing halves 256 and 258 apart during extension and retraction of the leash.

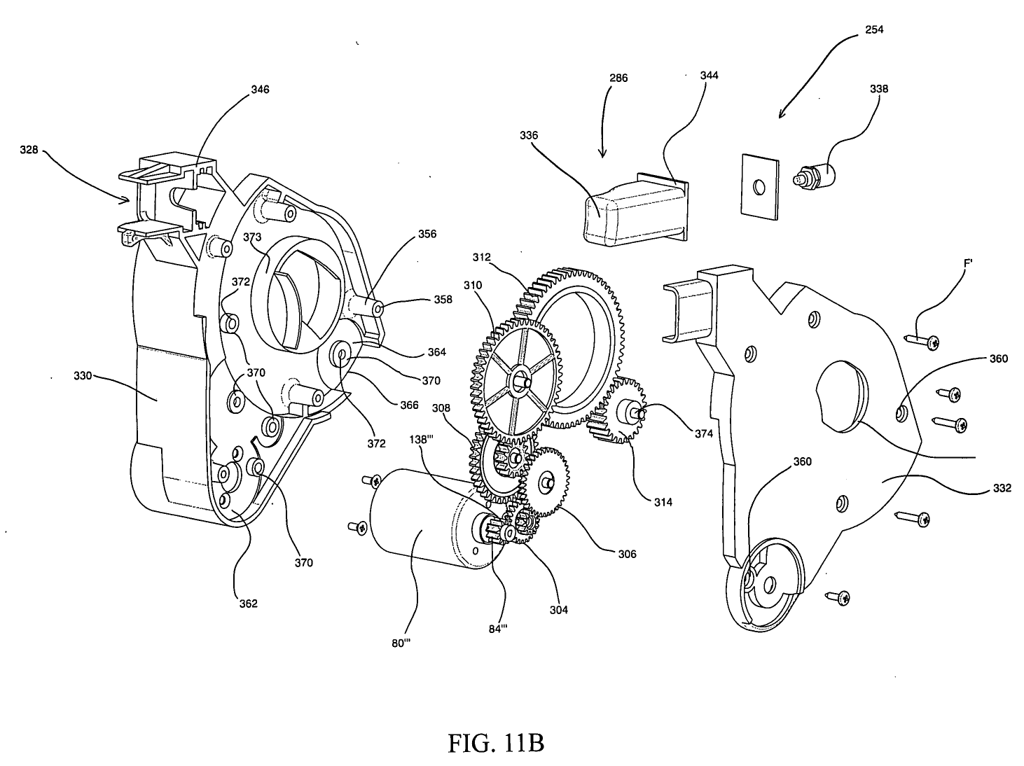

With reference to FIG. 11A, located adjacent the leash opening 272 is a light assembly 276 comprising a light bulb 278, a clear lens 280 and a reflector 282. The light assembly can be operated by a trigger assembly 286 located near the handle portion 252 of the housing 250. The power supply used to power the light assembly 276 may comprise conventional batteries 72′″ in a battery pack contained in a battery compartment 290 defined in a handle of the device. It is appreciated that the power supply may also include a photovoltaic cell and the like.

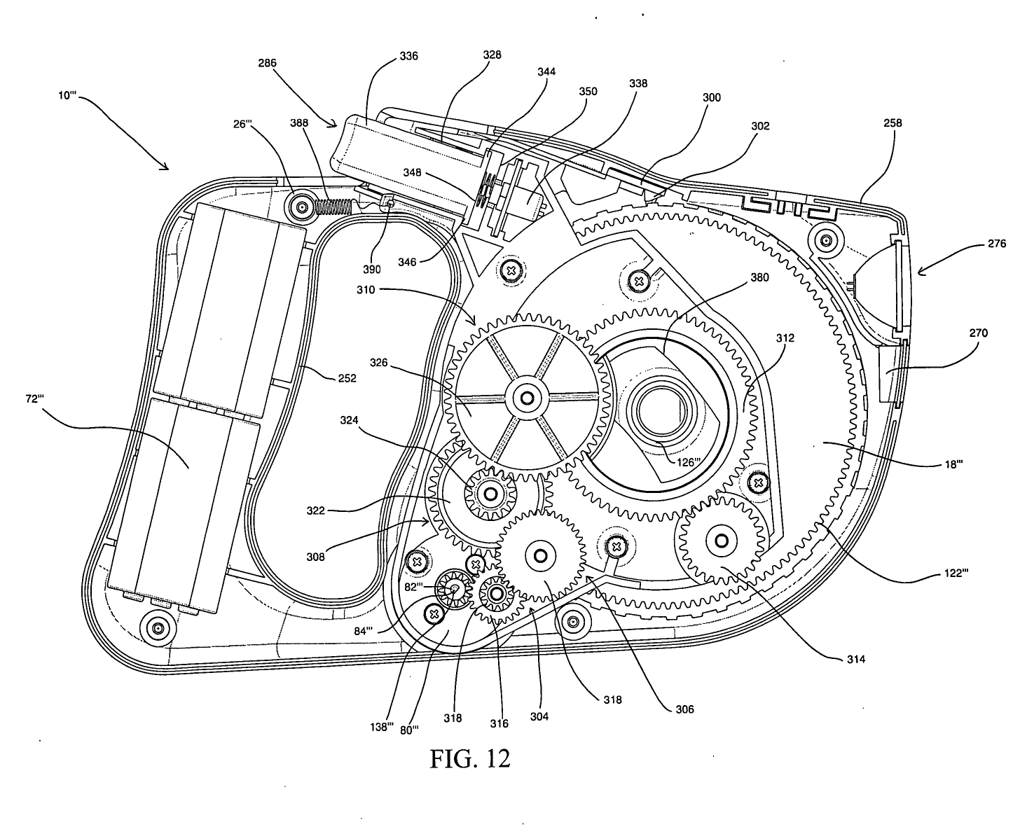

As previously described with respect to the first embodiment of the present invention, the spool 18′″ includes a hub 108′″ and first and second flanges 110′″ and 112′″ extending radially from the hub, a periphery of both flanges including teeth 114′″ and 116′″, respectively. Extending outwardly from the second flange 112′″ is a lip 120′″ including teeth 122′″ disposed radially about an inner surface. As shown in FIGS. 12-14, the teeth 122′″ are engaged by the spooling mechanism 254. A portion (not visible) of the hub 108′″ is slightly offset from the first flange 110′″ thus defining a recess (not visible) for housing a washer 292. As shown in FIG. 11A, a hollow stem 126′″ extends outwardly form the second flange 116′″, a longitudinal axis of the stem being coincident with a rotational axis of the spool 18′″. The spool 18′″ includes a mounting opening (not shown) adapted to rotatably receive a shaft portion 294 extending from the second half 258 of the housing 14′″. Thus, the spool can freely rotate in the housing.

Referring still to FIG. 11A, located above the handle portion 252 is a leash stop lock button 70′″ for controlling the amount of leash that is extended or retracted within the housing 250. The leash stop lock button 70′″ is located proximate to the handle portion 252 such that when a user is gripping the handle portion, the stop lock button may be activated by a finger of the same hand holding the handle portion. The leash stop lock button 70′″ is connected to an arm 298 and a planar member 300. The planar member includes a pair of projections 302 located on a bottom surface for engaging the teeth 114′″ and 116′″ of the spool 18′″ about which the leash is coiled. The leash stop lock button 70′″ can be biased by a spring (not shown). In the locked position, the projections 302 of the planar member 300 engage the teeth 114′″ and 116′″ of the spool 18′″ and prevent the movement of the spool thereby limiting the amount of leash that extends from the housing 250. In the unlocked position, the projections 302 of the planar member 300 are clear of the teeth 114′″ and 116′″ allowing the spool 18′″ to freely rotate.

With reference now to FIGS. 11B-14, the spooling mechanism 254 includes a motor 80′″ having a spur gear 84′″ rotatably mounted on a drive shaft 82′″, first, second, third and fourth increasingly larger compound gears 304, 306, 308, and 310, respectively, and first and second drive gears 312 and 314. Similar to the third embodiment, the compound gears include a small gear portion concentrically secured to a large gear portion.

In operation, the spooling mechanism is actuated by the trigger assembly 286, the trigger assembly actuating the motor 80′″ which, in turn, rotates the spur gear 84′″. The spur gear engages the large gear portion 316 of the first compound gear 304 thereby providing a high gear ratio between the spur gear and the first compound gear. The small gear portion 318 of the first compound gear 304 engages the large gear portion 320 thereby actuating the second compound gear 306. The small gear portion (not shown) of the second compound gear 306 engages the large gear portion 322 of the third compound gear 308 thereby actuating the third compound gear. The small gear portion 324 of the third compound gear 308 engages the large gear portion 326 of the fourth compound gear 310 thereby actuating the fourth compound gear. The small gear portion (not shown) of the fourth compound gear 310 actuates the first drive gear 312 which, in turn, actuates the second smaller drive gear 314. As will be described in further detail below, the second drive gear 314 engages the teeth 122′″ thereby actuating the spool 18′″. As the spool rotates in a counterclockwise direction, the leash (not shown), which has one end secured to the spool, retracts and is coiled about the spool. Thus, the gear arrangement of the present embodiment can also provide approximately a 500 to 1 gear reduction. Of course, other gear reduction ranges are also contemplated, depending on the required power for the spool 18′″. That, in turn, is dependent on the size of the pet.

As previously mentioned, such a gear reduction will allow the motor 80′″, which can be a conventional fractional horsepower electric motor powered by conventional batteries 72′″, to retract the leash, even when tethered to a pet pulling in the opposite direction. Thus, this gear reduction enables enable a pet owner to retract the leash into the housing 250 when the pet exerts more tension on the leash than the retraction force supplied by the spring bias on the spool 18′″ on which the leash is wrapped.

Referring to FIGS. 11B and 12, the trigger assembly 286, which is housed in a channel 328 defined by a first half 330 and a second half 332 of a gear housing 334, includes a cap button 336 and a switch assembly 338. The switch assembly 338 is electrically connected to the batteries 72′″ which also provide power to the motor 80′″.

The cap button 336 includes a flange 344 which abuts against a bottom surface 346 of the channel 328. A projection (not shown) can extend from an inner top surface of the cap button 336 into the channel 328 and is dimensioned to receive a spring 348. The spring is positioned in a compressed state between the inner top surface of the cap button and a channel shelf 350. Thus, the spring outwardly biases the cap button. The switch assembly 338, which actuates the spool mechanism 254, is also mounted in the channel 328. To engage the switch assembly 338, the cap button 336 is depressed thereby moving the projection into contact with the switch assembly.

With continued reference to FIG. 11B, the gear housing 334, which is pivotable about a pivot axis 138′″ defined by the drive shaft 82′″ of the motor 80′″, can be a plastic molded component and the first and second halves 330 and 332 of the gear housing 334 may be secured together by suitable fasteners. In this embodiment, a plurality of corresponding bosses 356 extend outwardly from the second half 332, each boss including an aperture 358 for receiving a fastener F′ which threadingly engages the aperture through recessed openings 360 located on the first half 330.

The first half 330 of the gear housing 334 includes a motor housing 362 and a recess 364 having an opening 366. The recess is dimensioned to receive the second drive gear 314 and the opening 366 allows a portion of the second drive gear to extend out of the gear housing for engaging the spool 18′″ (FIGS. 12-14). The second half 332 further includes gear mounts 370 having apertures 372 dimensioned to receive gear shafts 374 for each compound gear and each drive gear. Note that the large second drive gear 312 is rotatably mounted on a collar 373 extending away from a face of the first gear housing half 330.

As shown in FIGS. 11A and 11B, the first and second halves 330 and 332 of the gear housing 334 also include corresponding elongated openings 380 which allow the spooling mechanism 254 to be mounted on the stem 126′″ of the spool 18′″.

The positioning of the spooling mechanism 254 relative to the spool 18′″ is shown in FIGS. 12-14. As shown in FIG. 12, the trigger assembly 286 is not depressed and the second drive gear 314 is spaced from the teeth 122′″ of the spool 18′″. As such, in this first position, the spool can freely rotate in the housing 250.

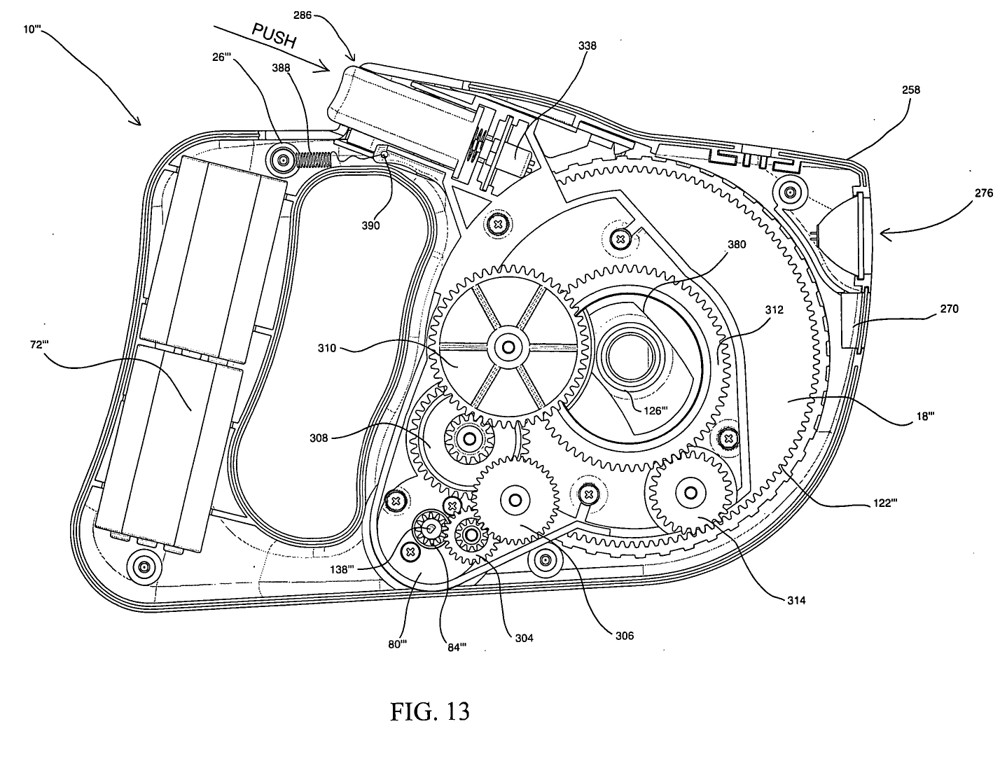

As shown in FIG. 13, the trigger assembly 286 is only partially depressed so that the switch assembly 338 is not engaged. In this second position, the spooling mechanism 254, again which is mounted on the stem 126′″ of the spool 18′″, the stem extending through the corresponding elongated openings 354 in the first and second halves 330 and 332 of the gear housing 334, pivots about the pivot axis 138′″. The second drive gear 314 will engage the teeth 122′″ of the spool 18′″ thereby locking the spool in a fixed position. As such, the leash will not extend any farther from the housing 250.

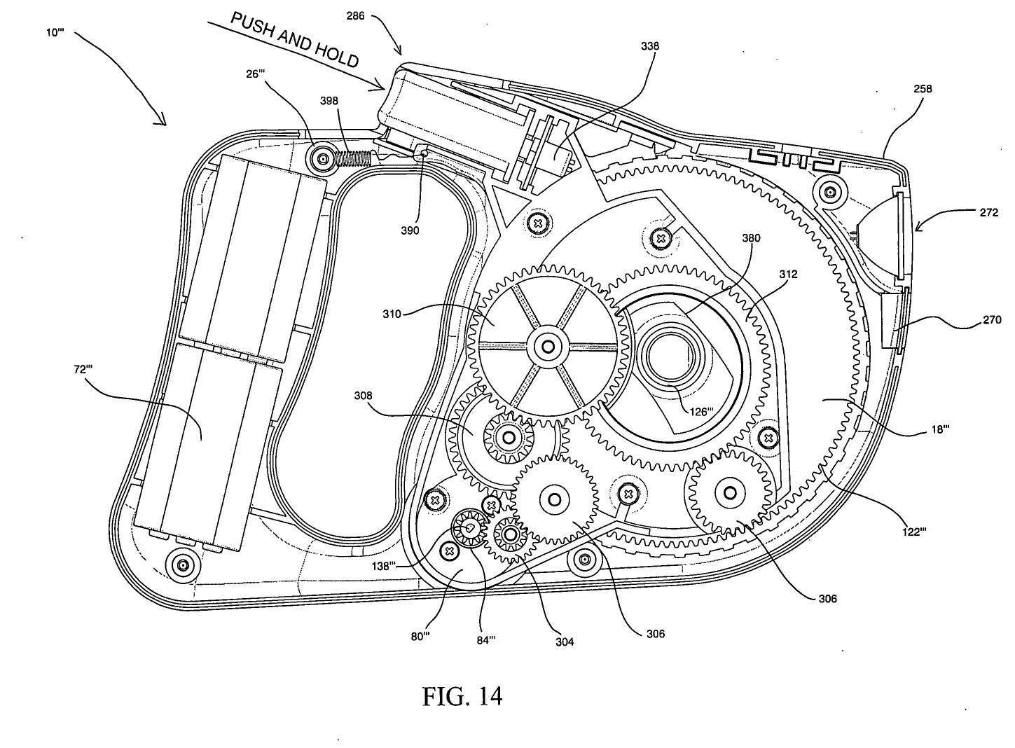

As shown in FIG. 14, the trigger assembly 286 is fully depressed and held in this depressed state so that the switch assembly 338 is engaged. In this third position, the motor 80′″ will actuate thereby actuating the compound gears 304, 306, 308 and 310 and the drive gears 312 and 314 of the spooling mechanism 254. This actuation will, in turn, cause the second drive gear 314 to actuate the spool 18′″ causing the spool to rotate in a counterclockwise direction. The leash, which is secured to the spool, will retract and coil around the spool.

A spring 388 can be secured to a tab 390 of the gear housing 334 and one of the bosses 26′″ extending from the second half 258 of the housing 250 near the handle 252. As the trigger assembly 286 is released from the above described third position, the spring 388 causes the spooling mechanism 254 to pivot about the pivot axis 138′″ into the first position and out of engagement with the spool 18′″ thereby allowing the spool to again freely rotate within the housing 250.

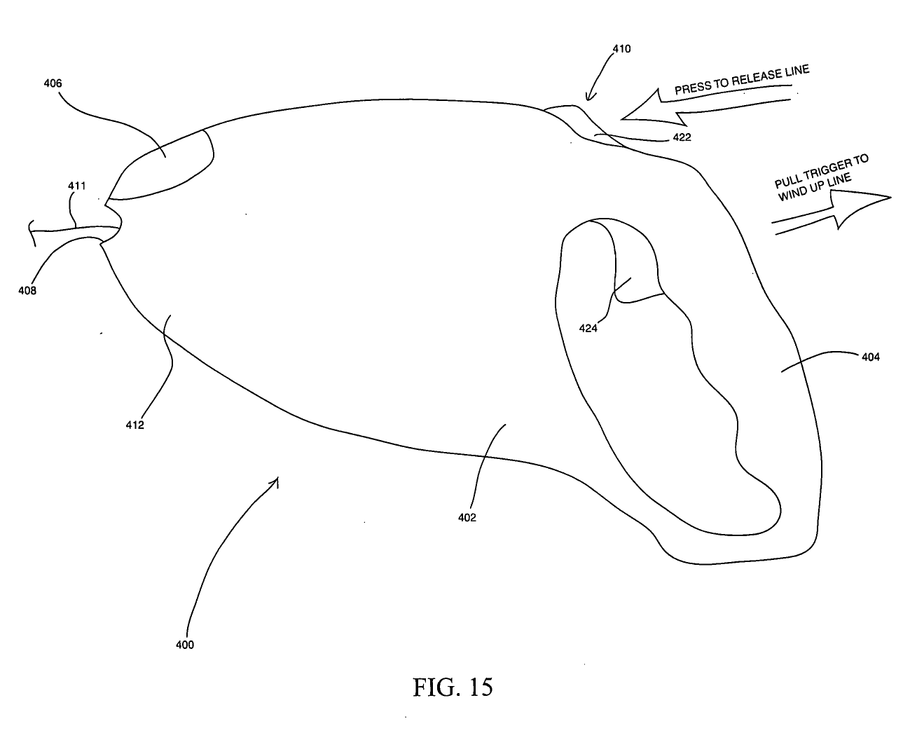

Similar to the aforementioned embodiment, a fifth embodiment of a motorized pet leash assembly 400 is shown in FIG. 15. In this embodiment, the leash assembly includes a housing 402 having an ergonomically shaped handle or hand grip 404 which can be integrally fabricated with the housing. The housing 402 can be a plastic molded component. The housing includes a light assembly 406 located adjacent a leash opening 408. The light assembly can be operated by a switch, not shown. Alternatively, the light can be selectively actuated by a trigger assembly 410 located near the handle portion 404 of the housing 402. The trigger assembly selectively allows a pet to play out a leash 411 wound on a spool (not visible) in the housing 402. The power supply used to power the light assembly 406 may comprise conventional batteries (not visible) contained in a battery compartment (not visible) located in the housing.

In this embodiment, the device can also include an alarm. As shown in FIG. 15, an alarm grill 412 can be located at the front end of the housing 402. A volume control (not shown) can be located on the side of the housing for controlling the volume of the alarm. Triggering the alarm can be accomplished by a switch, not shown, mounted on the housing 402. Such an alarm may prove useful in scaring away other pets, which may be bothering the device holder's pet. Actuating the alarm may also flash the light 406 to scare such other pets, or for other purposes.

The trigger assembly 410, which is operatively coupled to similar components described in detail above (e.g. a spool and a spooling mechanism), includes a first portion 422 and a second portion 424. To allow a leash (not shown) to extend freely from the housing 402, the first portion 422 is pressed. It can be appreciated that in this position, the spooling mechanism is not engaged with the spool. In order to retract the leash, the second portion 424 is pulled thereby actuating the spooling mechanism which engages the spool causing the spool to rotate in a counterclockwise direction.

The exemplary embodiments have been described with reference to the preferred embodiments. Obviously, modifications and alterations will occur to others upon reading and understanding the preceding detailed description. It is intended that the exemplary embodiments be construed as including all such modifications and alterations insofar as they come within the scope of the appended claims or the equivalents thereof.

What is claimed is:

1. A motorized dog leash comprising:
a housing;
a battery mounted to the housing;
a motor mounted to the housing and electrically connected to the battery;
a gear train connected to an output shaft of the motor;
a spool rotatably mounted to the housing and engaged with the gear train;
a leash selectively wound on the spool, the leash including a distal end which protrudes from the housing; and
a trigger selectively actuating the motor to rotate the spool.

2. The motorized dog leash of claim 1, wherein the gear train includes at least one drive gear and at least one compound gear for achieving a desired gear reduction.

3. The motorized dog leash of claim 2, wherein the gear train comprises planetary arrangement.

4. The motorized dog leash of claim 3, wherein the at least one compound gear is smaller in diameter than the drive gear.

5. The motorized dog leash of claim 1, wherein the gear train obtains approximately a 500 to 1 gear reduction.

6. The motorized dog leash of claim 1, wherein the spool includes:
a hub, at least one radial flange attached to the hub,
a lip extending outwardly from the at least one flange, the lip and the at least one flange defining a cavity for housing a portion of the gear train, the lip including teeth disposed about an inner surface for engaging the gear train, and
a stem extending outwardly from the at least one flange, a longitudinal axis of the stem being coincident with an axis of rotation of the spool.

7. The motorized dog leash of claim 6, further comprising a support member, the support member being pivotable about the stem of the spool thereby bringing the gear train into contact with the teeth of the lip of the spool.

8. The motorized leash of claim 7, further comprising a contact arm secured to the support member, wherein as the leash is being wound about the spool, a portion of the leash engages the contact arm causing the support member to rotate out of engagement with the spool.

9. The motorized dog leash of claim 1, further comprising a support member, the support member being pivotable about the drive shaft of the motor around a pivot axis, the support member allowing the gear train to be selectively engaged with the spool as the trigger is being depressed.

10. The motorized leash of claim 1, further comprising a leash stop lock button mounted to the housing, adjacent the trigger, the leash stop lock operating in a first locked position to lock the spool, and in a second unlocked position that enables the spool to freely rotate.

11. The motorized dog leash of claim 11, wherein the leash stop lock button engages teeth disposed about a periphery of the spool.

12. The motorized dog leash of claim 1, wherein spool is spring biased enabling the spool to freely retract any slack in the leash.

13. A motorized dog leash comprising:
a housing;
a battery mounted to the housing;
a spool mounted to the housing, the spool having an axis of rotation;
a spooling mechanism for enabling a powered retraction of the leash, the spooling mechanism including a motor mounted to the housing and electrically connected to the battery, the motor having an axially rotated output drive shaft, and a gear train connected to the drive shaft for rotation therewith, the spooling mechanism being pivotable about the output drive shaft of the motor around a pivot axis for allowing the gear train to be selectively engaged with the spool;
a leash at least partially wound about the spool; and
a trigger assembly selectively actuating the spooling mechanism for extension or retraction of the leash.

14. The motorized leash of claim 13, wherein the gear train includes at least one drive gear and at least one compound gear for achieving a desired gear reduction.

15. The motorized dog leash of claim 13, wherein the gear train obtains approximately a 500 to 1 gear reduction.

16. The motorized dog leash of claim 13, wherein the spool includes:
a hub,
first and second radial flanges attached to opposed ends of the hub,
a lip extending axially from the second flange, the lip including teeth disposed about an inner surface for engaging the gear train, and
a stem extending axially from the second flange, a longitudinal axis of the stem being coincident with an axis of rotation of the spool.

17. The motorized dog leash of claim 16, wherein the spooling mechanism includes a support member, the support member including an elongated opening for receiving the stem, the stem limiting the pivotal movement of the support member.

18. A motorized dog leash comprising:
a housing;
a battery compartment located in the housing for accommodating a battery;
a spool rotatably mounted in the housing, the spool including at least one flange and a lip including teeth;
a spooling mechanism for enabling a powered retraction of the leash, the spooling mechanism including:
a motor electrically connected to the battery, the motor having an axially rotated output drive shaft,
a gear train including at least one drive gear and at least one compound gear, the gear train being connected to the drive shaft for rotation therewith, and
a support member pivotable about the output drive shaft of the motor around a pivot axis for allowing the gear train to be selectively engaged with teeth of the lip of the spool;
a leash at least partially wound about the spool; and
a trigger selectively actuating the spooling mechanism for extension or retraction of the leash.

19. The motorized dog leash of claim 18, wherein the spool further includes a stem extending outwardly from the at least one flange.

20. The motorized dog leash of claim 19, wherein the support member includes an elongated slot for receiving the stem of the spool, the stem limiting the pivotal movement of the support member.
